(19) United States
(12) Patent Application Publication
(10) Pub. No.: US 2019/0204617 A1
(43) Pub. Date: Jul. 4, 2019

(54) WEARABLE DEVICE

(71) Applicant: ZUNGLE INC., Seoul (KR)

(72) Inventors: Hee Wook Yang, Seoul (KR); Seok Woo Hong, Seoul (KR)

(73) Assignee: ZUNGLE INC., Seoul (KR)

(21) Appl. No.: 16/177,268

(22) Filed: Oct. 31, 2018

(30) Foreign Application Priority Data
Dec. 29, 2017 (KR) 10-2017-0184697
Mar. 30, 2018 (KR) 10-2018-0037497

(51) Int. Cl. G02C 5/14; H04R 5/02; G02C 11/00; G02C 5/22; H02J 7/00

(52) U.S. Cl. CPC G02C 5/143; H04R 5/02; H02J 7/0042; G02C 5/22; H02J 7/0052; G02C 11/10

(57) ABSTRACT

Disclosed is a wearable device including a first temple including a first bone conductive speaker and a first controller, and a second temple including a second bone conductive speaker and a second controller configured to wirelessly communicate with the first controller, in which the first controller and the second controller are configured to control the first bone conductive speaker and the second bone conductive speaker, respectively.

### CROSS-REFERENCE TO RELATED APPLICATIONS

This application claims the benefit under 35 USC § 119(a) of Korean Patent Application No. 10-2017-0184697 filed on Dec. 29, 2017, and Korean Patent Application No. 10-2018-0037497 filed on Mar. 30, 2018, in the Korean Intellectual Property Office, the entire disclosures of which are incorporated herein by reference for all purposes.

### BACKGROUND

### 1. Field

The following description relates to a wearable device.

### 2. Description of Related Art

A wearable device refers to an electronic device to be used by being attached to or worn on a portion of a body of a user. The wearable device is provided in various types, for example, a T-shirt, eyeglasses, a bracelet, a watch, shoes, and the like.

For example, an eyeglass-type wearable device has been developed to transfer visual information to a user through a lens thereof. The development focuses on improving various functions of the eyeglass-type wearable device to be provided to a user, and thus the shape or appearance of such a type of wearable device has become very different from that of general-type eyeglasses.

Thus, there is a desire for an eyeglass-type wearable device that may fully perform basic functions of receiving and transmitting sound information while not making a user feel reluctant to or uncomfortable with wearing it in daily life.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect provides a wearable device that may perform its functions even when a portion of components thereof is replaced.

According to an example embodiment, there is provided a wearable device including a first temple including a first bone conductive speaker and a first controller, and a second temple including a second bone conductive speaker and a second controller configured to wirelessly communicate with the first controller. The first controller and the second controller may control the first bone conductive speaker and the second bone conductive speaker, respectively.

The wearable device may further include a front frame to or from which the first temple and the second temple are to be attached or detached.

The first temple may further include a fastening part to be rotatably connected to the front frame. The fastening part may include a front fastening portion facing the front frame when the first temple is unfolded with respect to the front frame, an inner fastening portion facing the front frame when the first temple is folded with respect to the front frame, and a guide groove provided in a concave form between the front fastening portion and the inner fastening portion and configured to guide the front frame to be connected.

In a fastening space formed at a center of the fastening part, a vertical space of a portion in which the front fastening portion is provided and a vertical space of a portion in which the inner fastening portion is provided may be relatively smaller than a vertical space of a portion in which the guide groove is provided.

The front frame may include a connecting part including a protrusion to be fastened to a fastening hole formed in the fastening part. In the fastening space, the vertical space of the portion in which the guide groove is provided may increase as being farther away from the fastening hole.

The first controller and the second controller may be disposed adjacent to the front frame.

The first temple may further include a front receiving portion configured to receive the first bone conductive speaker and the first controller, a seating portion to be seated on an upper side of an ear of a user, and a rear receiving portion configured to receive a battery. Herein, the front receiving portion, the seating portion, and the rear receiving portion may be arranged in sequential order from the front frame towards a rear end of the first temple.

A distance between the first controller and the front frame may be less than a distance between the first controller and the first bone conductive speaker.

The seating portion may have a cross section smaller than that of the rear receiving to portion.

The first temple may further include an oblique potion extending downwards and outwards from an inner side of the first temple, and a user interface of the first controller configured to receive an input signal may be disposed in the oblique portion.

The first temple may include an outer cover including an outer side of the first temple, and an inner cover to be combined with the outer cover and including the oblique portion.

The first controller may include a printed circuit board (PCB) disposed inside the first temple, an antenna pattern electrically connected to the PCB, and the user interface electrically connected to the PCB.

When the outer cover is viewed from outside in a vertical direction, the outer cover may completely overlap the user interface.

The first controller may further include a support bracket disposed between the PCB and the user interface, and the antenna pattern may be disposed on the support bracket.

The first temple may include a charging terminal disposed at a rear end of the first temple and formed in a height direction of the first temple.

The wearable device may further include a charging port including an inner contour corresponding to an outer contour of the first temple such that the first temple is to be inserted therein, and a connector to be electrically connected to the charging terminal.

Other features and aspects will be apparent from the following detailed description, the drawings, and the claims.

### BRIEF DESCRIPTION OF THE DRAWINGS

FIG. 1 is a perspective view of a wearable device according to an example embodiment.

FIG. 2 is an exploded perspective view and a partially enlarged view of a wearable device of which a first temple is detached from a front frame according to an example embodiment.

FIG. 3 is a side view of a wearable device according to an example embodiment.

FIG. 4 is an inner side view and a partially enlarged view of a first temple according to an example embodiment.

FIG. 5 is an exploded perspective view of a first temple when viewed from inside according to an example embodiment.

FIG. 6 is an exploded perspective view of a first temple when viewed from outside according to an example embodiment.

FIG. 7 is a cross-sectional view of a first temple according to an example embodiment.

FIG. 8 is a front view of a wearable device when worn on a user according to an example embodiment.

FIG. 9 is a top view of a wearable device when worn on a user according to an example embodiment.

FIG. 10 is a perspective view of a first temple and a charging port before being combined with each other, and a partially enlarged view of the charging port according to an example embodiment.

FIG. 11 is a perspective view of a first temple and a charging port when combined with each other according to an example embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

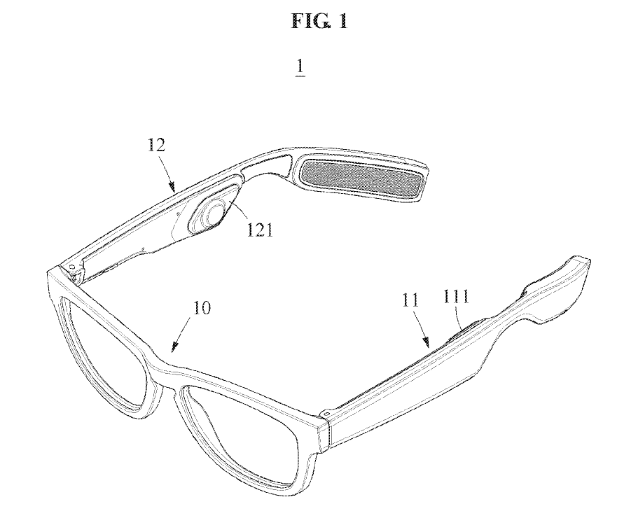

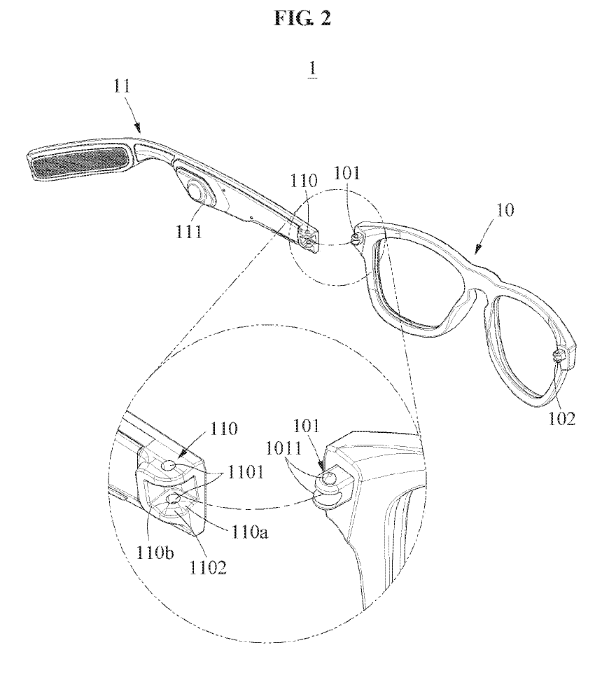

FIG. 1 is a perspective view of a wearable device according to an example embodiment. FIG. 2 is an exploded perspective view and a partially enlarged view of a wearable device of which a first temple is detached from a front frame according to an example embodiment.

Referring to FIGS. 1 and 2, a wearable device 1 may be used by being worn on a portion of a body of a user. The wearable device 1 may be provided in various types, for example, eyeglasses, a hairband, a headband, headphones, backphone headphones, and the like. Hereinafter, an eyeglass-type wearable device will be described as the wearable device 1 for convenience of description. However, the wearable device 1 is not limited to the example eyeglass type described in the foregoing.

The wearable device 1 includes a front frame 10, a first temple 11, and a second temple 12. The first temple 11 includes a first bone conductive speaker 111, and the second temple 12 includes a second bone conductive speaker 121. The first bone conductive speaker 111 and the second bone conductive speaker 121 come into contact with the body of the user to transfer violation to the user. For example, the first bone conductive speaker 111 and the second bone conductive speaker 121 may come into contact with respective temporal bones in front of ears to transfer vibration to the user.

The front frame 10 covers a front side of the user. For example, the front frame 10 may be a lens frame of eyeglasses or sunglasses. The front frame 10 includes a first connecting part 101 to be connected to or combined with the first temple 11, and a second connecting part 102 to be connected to or combined with the second temple 12. The first temple 11 and the second temple 12 are easily attachable to or detachable from the front frame 10 through the first connecting part 101 and the second connecting part 102, respectively.

The first temple 11 includes a first fastening part 110 to be rotatably connected to or combined with the first connecting part 101. For example, as enlarged in FIG. 2, the first fastening part 110 includes a fastening hole 1101 to receive at least a portion of the first connecting part 101.

The front frame 10 includes the first connecting part 101 including a protrusion to be fastened to the fastening hole 1101 of the first fastening part 110. For example, the first connecting part 101 may include a protrusion that may be inserted into the fastening hole 1101. The first fastening part 110 may include a fastening groove (not shown) to receive at least a portion of the first connecting part 101. For another example, the first fastening part 110 may include a protrusion, and the first connecting part 101 may receive the first fastening part 110.

The first fastening part 110 is provided at each on an upper side and a lower side, covering an upper side and a lower side of the first connecting part 101, respectively. For another example, the first connecting part 101 may cover an upper side and a lower side of the first fastening part 110.

The first fastening part 110 further includes a front fastening portion 110a, an inner fastening portion 110b, and a guide groove 1102.

The front fastening portion 110a faces the front frame 10 when the first temple 11 is unfolded with respect to the front fame 10. That is, the front fastening portion 110a faces the front frame 10 when an angle between the first temple 11 and the front frame 10 is its maximal. For example, when the angle between the first temple 11 and the front frame 10 is a first angle, the front fastening portion 110a of the first temple 11 may come into contact with the front frame 10. In this example, the first angle may be determined by a shape of the first temple 11 and the front frame 10. The first angle may be determined in a range between 80 degrees (°) and 100°, for example.

The inner fastening portion 110b faces the front frame 10 when the first temple 11 is folded with respect to the front frame 10. That is, when the angle between the first temple 11 and the front frame 10 is its minimal, the inner fastening portion 110b faces the front frame 10. For example, when the angle between the first temple 11 and the front frame 10 is a second angle, the inner fastening portion 110b of the first temple 11 may come into contact with the front frame 10. In this example, the second angle may be determined by a shape of the first temple 11 and the front frame 10. The second angle may be determined in a range between 0° and 20°, for example.

The guide groove 1102 is provided in a concave form between the front fastening portion 110a and the inner fastening portion 110b. The guide groove 1102 may assist the first connecting part 101 and the first fastening part 110 in attaching to and/or detaching from each other. The guide groove 1102 is formed in a direction towards a front side and an inner side of the first temple 11, or in a diagonal direction. For example, when the front fastening portion 110a faces 0° and the inner fastening portion 110b faces 90°, the guide groove 1102 may face approximately 45°. The guide groove 1102 may form an approximate U shape along with the front fastening portion 110a and the inner fastening portion 110b which are adjacent thereto. Due to the guide groove 1102, a vertical space of a fastening space formed at a center of the first fastening part 110 may not be consistent. For example, in the fastening space, a vertical space of a portion in which the front fastening portion 110a and the inner fastening portion 110b are provided may be relatively smaller, and a vertical space of a portion in which the guide groove 1102 is provided may be relatively greater. In addition, in the fastening space, the vertical space of the portion in which the guide groove 1102 is provided may increase as being farther away from the fastening hole 1101.

The first temple 11 and the front frame 10 may be easily detachable from each other only when they form a certain angle, and stably connected to or combined with each other in a general situation. In general, the first temple 11 and the front frame 10 of the wearable device 1 may form approximately 0° in a folded state or approximately 900 in an unfolded state. Thus, the first temple 11 may not be easily detached from the front frame 10 in a general situation. However, when the user desires to detach the first temple 11 from the front frame 10, the user may easily detach the first temple 11 from the front frame 10 after adjusting the angle between the first temple 11 and the front frame 10 to be approximately 45°. The angle of 45° may be formed temporarily while the first temple 11 is being folded or unfolded, and thus the user may detach the first temple 11 from the front frame 10 only when the user desires to do the same by forming the certain angle between the first temple 11 and the front from 10.

The second temple 12 includes the second bone conductive speaker 121 and a second fastening part (not shown).

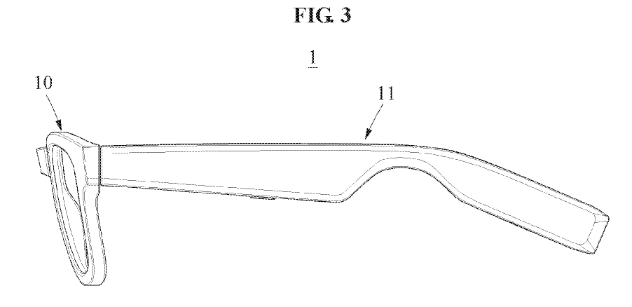

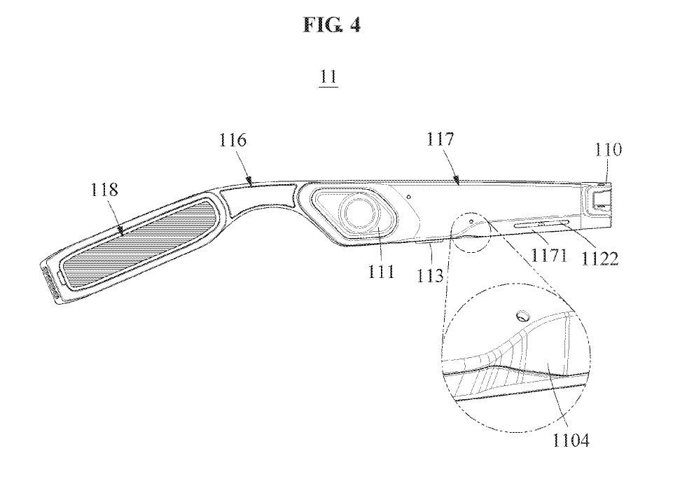

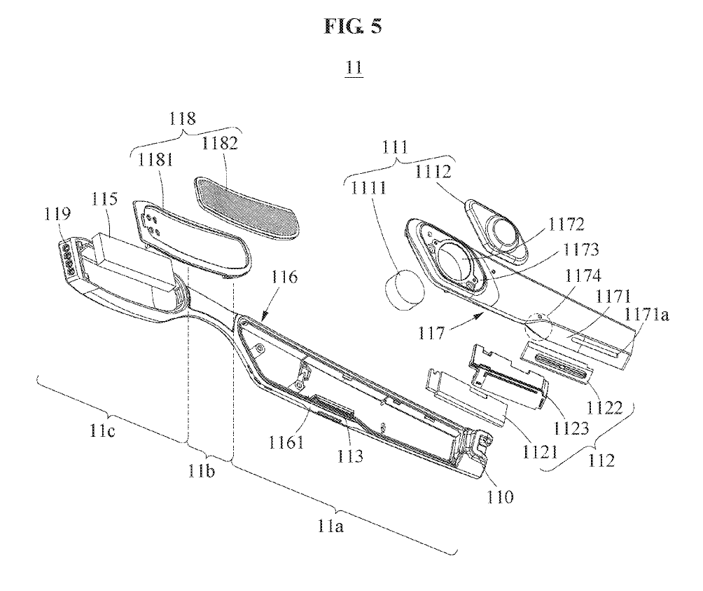

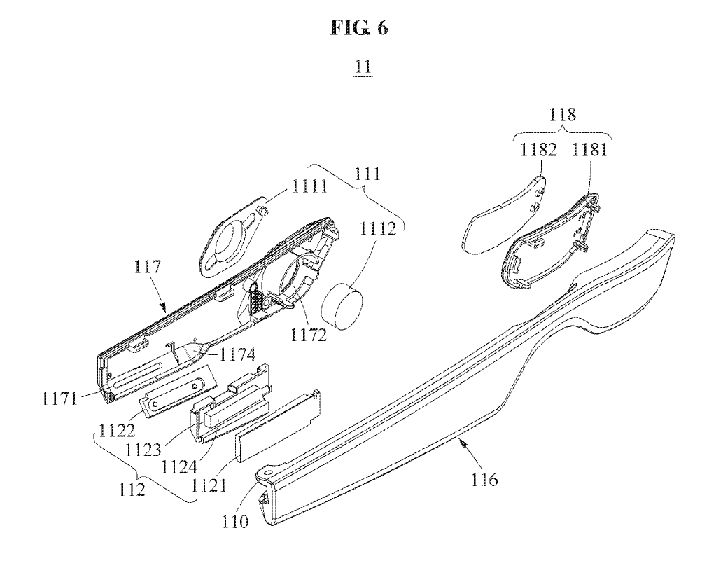

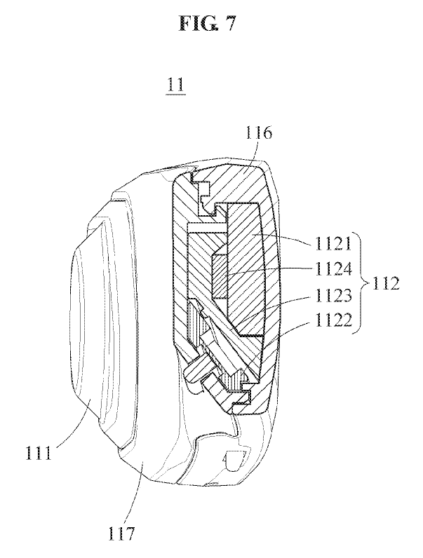

FIG. 3 is a side view of a wearable device according to an example embodiment. FIG. 4 is an inner side view and a partially enlarged view of a first temple according to an example embodiment. FIG. 5 is an exploded perspective view of a first temple when viewed from inside according to an example embodiment. FIG. 6 is an exploded perspective view of a first temple when viewed from outside according to an example embodiment. FIG. 7 is a cross-sectional view of a first temple according to an example embodiment.

FIGS. 3 through 7 illustrate the first temple 11. Hereinafter, the ordinal numbers, for example, first and second, will be omitted for convenience of description. For example, the first temple 11 will be simply referred to as “temple 11” hereinafter. In addition, components of the first temple 11 and components of the second temple 12 are mostly symmetrical to each other, and thus the description of the first temple 11 may also be applied to the second temple 12 unless otherwise specified.

Referring to FIGS. 3 through 7, the temple 11 is broadly divided into a front receiving portion 11a, a seating portion 11b, and a rear receiving portion 11c. Herein, the front receiving portion 11a, the seating portion 11b, and the rear receiving portion 11c are arranged in sequential order in a direction from the front frame 10 to a rear end of the temple 11.

The front receiving portion 11a is a portion close to the front frame 10. The front receiving portion 11a is formed by an outer cover 116 and a front inner cover 117. The front receiving portion 11a receives or accommodates the bone conductive speaker 111 and a controller 112. The bone conductive speaker 111 is disposed at a rear portion of the front receiving portion 11a and the controller 112 is disposed at a front portion of the front receiving portion 11a, and a hollow may be provided between the bone conductive speaker 111 and the controller 112. The hollow may reduce a magnitude of vibration that is transferred from the bone conductive speaker 111 to the front frame 10.

The seating portion 11b is to be seated on an upper side of an ear of a user. The seating portion 11b is disposed between the front receiving portion 11a and the rear receiving portion 11c. The seating portion 11b may have a cross section smaller than that of the rear receiving portion 11c. An intensity of vibration generated in the front receiving portion 11a may be reduced while passing through the seating portion 11b. Through a space in the seating portion 11b, a line (not shown) connecting a battery 115 and the bone conductive speaker 111 and a line (not shown) connecting the battery 115 and the controller 112 may pass through a hollow of the seating portion 11b.

The rear receiving portion 11c is a portion that is farthest away from the front frame 10. The rear receiving portion 11c receives or accommodates the battery 115. The rear receiving portion 11c may have an internal structure corresponding to a shape of the battery 115 such that the battery 115 is not shaken therein.

A moment acting on the temple 11 may be approximately balanced based on the seating portion 11b seated on the ear of the user. That is, by positioning the battery 115 which is relatively heavy at a rear side yet relatively closer to the seating portion 11b, and by positioning the bone conductive speaker 111 and the controller 112 which are relatively light at a front side yet relatively far away from the seating portion 11b, the balance may be maintained. Thus, through such a weight distribution, the user may feel better and more comfortable while wearing the wearable device 1.

The temple 11 includes the bone conductive speaker 111, the controller 112, a power supply switch 113, the battery 115, the outer cover 116, the front inner cover 117, a rear inner cover 118, and a charging terminal 119.

The bone conductive speaker 111 includes a speaker body 1111 and a speaker panel 1112. The speaker body 1111 is disposed in the front receiving portion 11a and configured to generate vibration. The speaker panel 1112 is configured to transfer, to the body of the user, the vibration generated from the speaker body 1111.

The bone conductive speaker 111 is disposed ahead of the seating portion 11b. In such a case, the vibration generated from the bone conductive speaker 111 may be transferred through the speaker panel 1112 through bone conduction. Alternatively, the vibration may also be transferred to an eardrum of the user through air as a medium.

The bone conductive speaker 111 may be electrically connected to other components of the temple 11. For example, the bone conductive speaker 111 may be electrically connected to one or more of the controller 112, the power supply switch 113, and the battery 115. In the drawings, wires and wiring are omitted for ease of understanding.

The controller 112 receives an input signal through an oblique portion 1171 to control the bone conductive speaker 111. The controller 112 is disposed adjacent to the front frame 10. A distance between the controller 112 and the front frame 10 may be less than a distance between the controller 112 and the bone conductive speaker 111. The controller 112 includes a printed circuit board (PCB) 1121, a user interface 1122, a support bracket 1123, and an antenna pattern 1124.

The PCB 1121 is disposed inside the temple 11. The front receiving portion 11a has an internal structure to which the PCB 1121 is fixed without the PCB 1121 being shaken therein. The PCB 1121 controls the bone conductive speaker 111 based on a signal input from the user interface 1122 and/or from outside through the antenna panel 1124.

The use interface 1122 is electrically connected to the PCB 1121 and disposed in the oblique portion 1171. When the temple 11 is viewed in a vertical direction, an outer side of the temple 11 may completely overlap the user interface 1122. That is, when the temple 11 is viewed from the outside, the user interface 1122 may be covered by the outer cover 116 of the temple 11. According to an example embodiment, the wearable device 1 may be recognized as general-type eyeglasses because the user interface 1122 is covered or hidden. The use interface 1122 may include, for example, a touch panel or a vertically movable button on a surface of the oblique portion 1171.

The support bracket 1123 is disposed between the PCB 1121 and the user interface 1122. The support bracket 1123 prevents a pressure applied to the user interface 1122 from being applied to the PCB 1121. The support bracket 1121 is provided in a form of two faces being bent and in contact with each other. A lower face of the support bracket 1123 supports the user interface 1122, and an upper face of the support bracket 1123 is in contact with the PCB 1121.

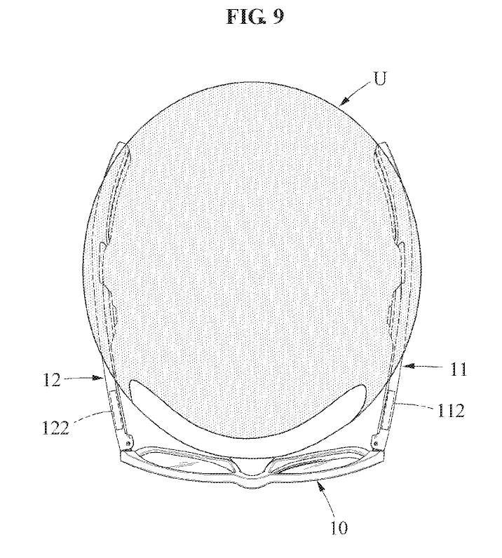

The support bracket 1123 includes a recessed groove on an inner side thereof. That is, a space is formed between the support bracket 1123 and the PCB 1121. The antenna pattern 1124 is disposed in the groove of the support bracket 1123. For example, the antenna pattern 1124 is formed on an inner side of the groove of the support bracket 1123, which is simply illustrated as a box. Through such an illustrated structure, the antenna pattern 1124 and the PCB 1121 may be arranged compactly without a need to elongatedly extend the PCB 1121 in a longitudinal direction of the temple 11 to secure an area for the antenna pattern 1124. In addition, through the antenna pattern 1124, performance in wireless communication between a pair of temples 11 and 12 may be improved as to be described later with reference to FIG. 9.

The antenna pattern 1124 wirelessly transmits and/or receives a signal to and/or from outside or an external source. For example, a first controller 112 of the first temple 11 may exchange a signal with a second controller 122 of the second temple 12. The antenna pattern 1124 is electrically connected to the PCB 1121. For example, the user interface 1122 of the first temple 11 may have a volume adjusting function. When operating the user interface 1122 of the first temple 11, the PCB 1121 of the first temple 11 may control the bone conductive speaker 111 based on an input signal. For example, using the user interface 1122 of the first temple 11, respective volumes of a pair of bone conductive speakers disposed in the first temple 11 and the second temple 12, respectively, may be adjusted to be the same. In addition, the PCB 1121 of the first temple 11 may transfer, through the antenna pattern 1124, a signal to an antenna pattern (not shown) of the second temple 12 that is disposed on an opposite side of the antenna pattern 1124. The antenna pattern of the second temple 12 may transfer, to a PCB (not shown) of the second temple 12, the signal received from the antenna pattern 1124 of the first temple 11. The PCB of the second temple 12 may control a second bone conductive speaker, or the second bone conductive speaker 121 illustrated in FIG. 1. As described above, the first controller 112 and the second controller (not shown) may communicate wirelessly, and thus control the first bone conductive speaker 111 and the second bone conductive speaker 121 concurrently as illustrated in FIG. 1.

As described above, both sides, or the first temple 11 and the second temple 12, communicate wirelessly, and thus the wearable device 1 may perform its functions although the front frame 10 is replaced. Thus, the user may use various front frames of various designs by replacing the front frame 10 at relatively low costs based on a preference or taste of the user.

The power supply switch 113 is disposed on a lower side of the temple 11, and at least a portion of the power supply switch 113 may be exposed downwards. The user may apply a pressure to the power supply switch 113 to turn on or off a power supply of the wearable device 1. The power supply switch 113 is disposed on the lower side of the temple 11, and thus the user may easily press the power supply switch 113 while the user is putting on or taking off the wearable device 1. For example, the user may not need to additionally turn off the power supply of the wearable device 1 after taking off the wearable device 1 in operation.

The battery 115 supplies power to the bone conductive speaker 111 and the controller 112.

The outer cover 116 includes an outer side and a lower side of the temple 11.

The inner covers 117 and 118 are combined with the outer cover 116. When the outer cover 116 and the inner covers 117 and 118 are combined, the temple 11 may have a hollow inside the temple 11. The inner covers 117 and 118 include an inner side and the oblique portion 1171 of the temple 11. Although the inner covers 117 and 118 are separately illustrated as the front inner cover 117 and the rear inner cover 118, the front inner cover 117 and the rear inner cover 118 may be integrally formed.

The front inner cover 117 includes the oblique portion 1171, a speaker receiving hole 1172, a panel support 1173, and a guide portion 1174.

The oblique portion 1171 extends downwards and outwards from an inner side of the temple 11, when the user wears the wearable device 1. The oblique portion 1171 forms a certain angle, for example, 30° to 60°, with an inner side of the front inner cover 117. In addition, the oblique portion 1171 forms a certain angle, for example, 30° to 60°, with a lower side of the outer cover 116. The oblique portion 1171 obliquely connects the inner side of the front inner cover 117 and the lower side of the outer cover 116. The inner side of the front inner cover 117 and the lower side of the outer cover 116 may thus be smoothly connected through the oblique portion 1171, and a cross section of the temple 11 may have a pentagonal shape.

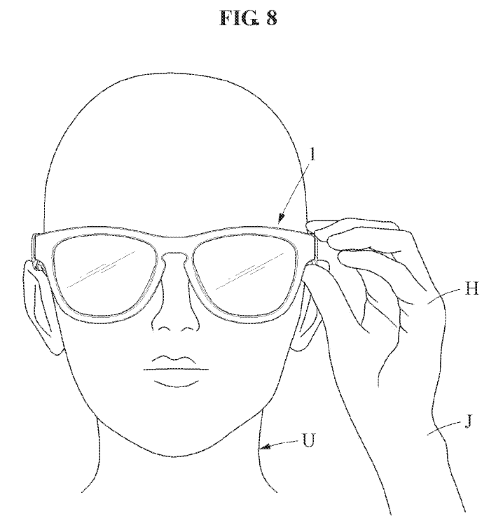

The user may easily operate the user interface 1122 through the oblique portion 1171. As to be described later with reference to FIG. 8, through the oblique portion 1171, the user may easily operate the user interface 1122 with a thumb of the user while a hand of the user naturally puts thereon without a need to bend a wrist of the user inwardly or outwardly.

A width of the guide portion 1174 increases towards the oblique portion 1171. That is, the guide portion 1174 gradually widens towards a front side from a rear side thereof. The guide portion 1174 is disposed between a lower side of the temple 11 in which the power supply switch 113 is provided and the oblique portion 1171 in which the user interface 1122 is provided. When viewed from inside, the guide portion 1174 is provided in a triangular shape. In addition, the guide portion 1174 is provided in an outwardly curved shape. That is, when viewed from below, the guide portion 1174 is provided in a concave shape. Through such a shape, the guide portion 1174 may provide the user with tactile information such that a thumb of the user touching the guide portion 1174 may move to where the user interface 1122 is positioned along the guide portion 1174, when the thumb is positioned behind the user interface 1122 while a hand of the user is naturally grabbing or holding the temple 11.

The rear inner cover 118 includes a rear inner cover body 1181 supporting one face of the battery 115, and a friction member 1182 used to increase friction with a body of the user.

The charging terminal 119 is disposed at a rear end of the temple 11. The charging terminal 119 is disposed in a height direction of the temple 11. The charging terminal 119 is disposed adjacent to the battery 115 and may thus increase charging efficiency of the battery 115. For example, the charging terminal 119 may be provided as a terminal fixed to the temple 11, or a pogo pin elastically deformable in a longitudinal direction of the temple 11.

FIG. 8 is a front view of a wearable device when worn on a user according to an example embodiment.

Referring to FIG. 8, a user (U) may grab or hold the wearable device 1 by a hand (H) without a burden or a pressure on a wrist joint (J). As described above, the user interface 1122 of the wearable device 1 is disposed in the oblique portion 1171 as illustrated in FIG. 5. For example, when the user interface 1122 is disposed on an inner side face of the temple 11 (refer to FIG. 5), the user may need to unnaturally extend the wrist joint outwardly. In addition, when the user interface 1122 is disposed on a lower side face of the temple 11, the user may need to unnaturally bend or flex the wrist joint inwardly. However, through the oblique portion 1171, such unnatural movements may not be needed, and the user may thus naturally operate the user interface 1122 of the wearable device 1 when the user is doing an outdoor activity such as, for example, running, cycling, hiking, and mountain climbing.

FIG. 9 is a top view of a wearable device when worn on a user according to an example embodiment.

Referring to FIG. 9, the first temple 11 and the second temple 12 disposed at both sides of the front frame 10 of the wearable device 1 may communicate with each other through the first controller 112 and the second controller 122, respectively. The first controller 112 and the second controller 122 may be disposed close to the front frame 10. That is, a distance between the first controller 112 and the front frame 10 may be less than a distance between the first controller 112 and the first bone conductive speaker 111 (refer to FIG. 1). Similarly, a distance between the second controller 122 and the front frame 10 may be less than a distance between the second controller 122 and the second bone conductive speaker 121 (refer to FIG. 1). In general, it is known that a wireless communication signal in a Bluetooth method may not easily pass through a human body. However, through such an arrangement described herein, the first controller 112 and the second controller 122 may more effectively perform wireless communication with each other with less interference from a body of the user.

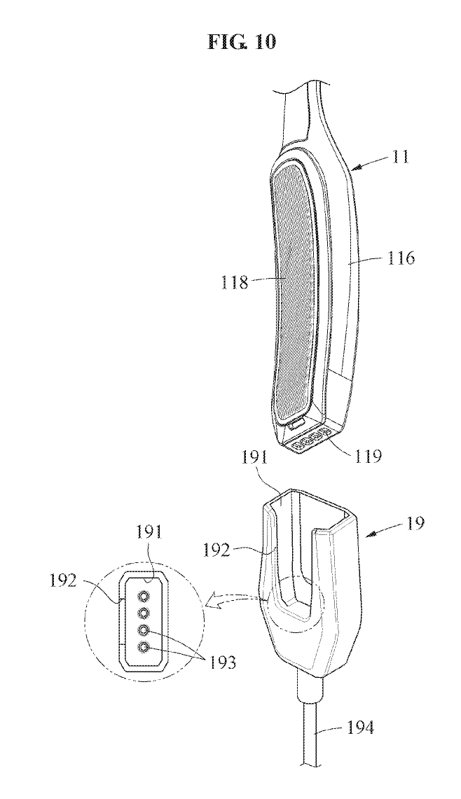

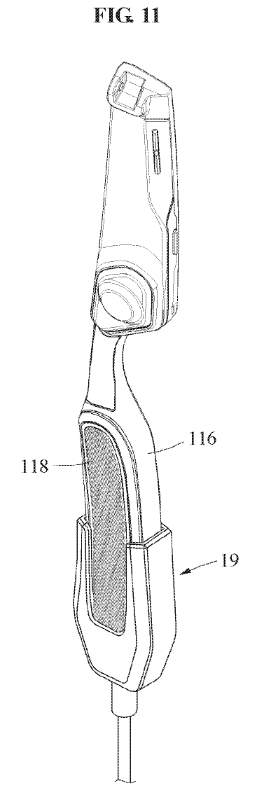

FIG. 10 is a perspective view of a first temple and a charging port before being combined with each other, and a partially enlarged view of the charging port according to an example embodiment. FIG. 11 is a perspective view of a first temple and a charging port when combined with each other according to an example embodiment.

Referring to FIGS. 10 and 11, the wearable device 1 further includes a charging port 19. The charging port 19 includes an inner contour 191 corresponding to an outer contour of the first temple 11 such that the first temple 11 may be inserted therein. Herein, the outer contour of the first temple 11 may be determined by the outer cover 116 and the rear inner cover 118.

The charging port 19 includes a port groove 192, a connector 193, and a charging line 194.

The port groove 192 is formed in an upper portion of the charging port 19 and is grooved downwardly. A user may easily detach the first temple 11 by pushing a finger into the port groove 192.

When the first temple 11 is inserted in the charging port 19, the connector 193 is electrically connected to the charging terminal 119. The connector 193 may be provided in a form of a terminal fixed to the charging port 19, or a form of pogo pin that is elastically deformable based on a direction in which the first temple 11 is to be inserted.

The charging line 194 electrically connects the charging terminal 119 to an external power supply.

According to an example embodiment described herein, a wearable device may perform its functions although some of components thereof is replaced with another. For example, an eyeglass-type wearable device may perform a function of a bone conductive speaker although a lens frame of the eyeglass-type wearable device is replaced.

In addition, the wearable device may effectively perform its functions through wireless communication between separate components thereof. For example, a left-side temple of an eyeglass-type wearable device may adjust a volume of bone conductive speakers on both sides and a right-side temple may change a playlist of the bone conductive speakers on both sides.

Further, the wearable device may be easy to operate. For example, an eyeglass-type wearable device may enable a user to readily operate a user interface thereof without a burden or a pressure on a wrist of the user because the user interface is formed in an oblique direction on an inner side and a lower side of a temple of the eyeglass-type wearable device.

Furthermore, the wearable device may structurally guide a user to a position of a user interface of the wearable device through a guide portion thereof. Thus, the user may readily find the position of the user interface by the feel or tactile sensation without a need to directly verify the position of the user interface with eyes of the user.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wearable device comprising:
a first temple including a first bone conductive speaker and a first controller; and
a second temple including a second bone conductive speaker, and a second controller configured to wirelessly communicate with the first controller,
wherein the first controller and the second controller are configured to control the first bone conductive speaker and the second bone conductive speaker, respectively.

2. The wearable device of claim 1, further comprising:
a front frame to or from which the first temple and the second temple are to be attached or detached.

3. The wearable device of claim 2, wherein the first temple further includes a fastening part to be rotatably connected to the front frame,
wherein the fastening part includes:
a front fastening portion facing the front frame when the first temple is unfolded with respect to the front frame;
an inner fastening portion facing the front frame when the first temple is folded with respect to the front frame; and
a guide groove provided in a concave form between the front fastening portion and the inner fastening portion and configured to guide the front frame to be connected.

4. The wearable device of claim 3, wherein, in a fastening space formed at a center of the fastening part, a vertical space of a portion in which the front fastening portion is provided and a vertical space of a portion in which the inner fastening portion is provided are relatively smaller than a vertical space of a portion in which the guide groove is provided.

5. The wearable device of claim 4, wherein the front frame includes a connecting part including a protrusion to be fastened to a fastening hole formed in the fastening part,
wherein, in the fastening space, the vertical space of the portion in which the guide groove is provided increases as being farther away from the fastening hole.

6. The wearable device of claim 2, wherein the first controller and the second controller are disposed adjacent to the front frame.

7. The wearable device of claim 6, wherein the first temple further includes:
a front receiving portion configured to receive the first bone conductive speaker and the first controller;
a seating portion to be seated on an upper side of an ear of a user; and
a rear receiving portion configured to receive a battery,
wherein the front receiving portion, the seating portion, and the rear receiving portion are arranged in sequential order from the front frame towards a rear end of the first temple, and
the seating portion has a cross section smaller than that of the rear receiving portion.

8. The wearable device of claim 7, wherein a distance between the first controller and the front frame is less than a distance between the first controller and the first bone conductive speaker.

9. The wearable device of claim 1, wherein the first temple further includes an oblique potion extending downwards and outwards from an inner side of the first temple,
wherein a user interface of the first controller configured to receive an input signal is disposed in the oblique portion.

10. The wearable device of claim 9, wherein the first temple includes:
an outer cover including an outer side of the first temple; and
an inner cover to be combined with the outer cover and including the oblique portion.

11. The wearable device of claim 10, wherein the first controller includes:
a printed circuit board (PCB) disposed inside the first temple;
an antenna pattern electrically connected to the PCB; and
the user interface electrically connected to the PCB.

12. The wearable device of claim 11, wherein, when the outer cover is viewed from outside in a vertical direction, the outer cover completely overlaps the user interface.

13. The wearable device of claim 11, wherein the first controller further includes a support bracket disposed between the PCB and the user interface,
wherein the antenna pattern is disposed on the support bracket.

14. The wearable device of claim 1, wherein the first temple includes a charging terminal disposed at a rear end of the first temple and formed in a height direction of the first temple.

15. The wearable device of claim 14, further comprising:
a charging port including an inner contour corresponding to an outer contour of the first temple such that the first temple is to be inserted therein, and a connector to be electrically connected to the charging terminal.
